(19) United States
(12) Patent Application Publication
(10) Pub. No.: US 2019/0276671 A1
(43) Pub. Date: Sep. 12, 2019

(54) Bio-composite and Bioplastic Materials and Method

(71) Applicant: Cambond Limited, Cambridge, Cambridgeshire (GB)

(72) Inventors: Xiaobin ZHAO, Cambridge, Cambridgeshire (GB); Gareth ROBERTS, Cambridge, Cambridgeshire (GB); Elizabeth ROBERTS, Cambridge, Cambridgeshire (GB)

(21) Appl. No.: 16/345,668

(22) PCT Filed: Oct. 30, 2017
(86) PCT No.: PCT/GB2017/053255

§ 371 Date: Apr. 26, 2019

(30) Foreign Application Priority Data
Oct. 28, 2016 (GB) 1618241.2
Jun. 9, 2017 (GB) 1709200.8
Jun. 12, 2017 (GB) 1709342.8
Jul. 20, 2017 (GB) 1711698.9
Aug. 11, 2017 (GB) 1712921.4

(51) Int. Cl. C08L 97/02; C08L 23/12; C08L 67/04; B29B 9/06; B29D 22/00; B65D 1/16

(52) U.S. Cl. CPC C08L 97/02; C08L 23/12; C08L 67/04; B29B 9/06; B29D 22/003; B29K 2101/10; C08L 2205/16; C08L 2312/00; C08L 2207/20; C08L 2203/10; B65D 1/16

(57) ABSTRACT

A bio-composite material comprises protein-containing non-wood fibrous biomass comprising at least 6 wt % protein, and a cross-linking agent. The bio-composite material may optionally further contain wood biomass, or non-protein-containing non-wood biomass, and is formable into a bio-composite board to replace wood-based boards for a variety of applications. A bioplastic material comprises a bioadhesive, fibrous biomass and a plastic material, and is formable into a variety of products, such as a cup, using conventional plastic processing techniques. Suitable fibrous biomass may include used coffee grounds and a variety of other biomass. A method of forming a board from a bio-composite material, and a method of manufacturing a bioplastic are also provided.

The present invention relates to bio-composite materials and bioplastic materials, and to composite panels and cups formed from such materials. The invention further relates to methods of manufacturing bio-composite and bioplastic materials, and of manufacturing products from such materials.

The invention relates to a bio-composite material, a board formed from a bio-composite material, a method of forming a board from a bio-composite material, a bioplastic material, a method of manufacturing a bioplastic material, a cup formed from a bioplastic material, and a method of forming a cup from a bioplastic material, as defined in the appended independent claims to which reference should now be made. Preferred or advantageous features of the invention are set out in dependent subclaims.

### FIRST ASPECT OF THE INVENTION

### Manufacture Process of Biocomposite with Protein-Containing Non-Wood Fibrous Biomass

A first aspect of the invention provides a bio-composite panel manufactured using protein containing fibrous biomass. This biomass is used to partially or totally replace wood biomass in wood-based panels to make such bio-composite panels for applications in construction industry, packaging industry and automobiles industry.

### BACKGROUND—FIRST ASPECT OF THE INVENTION

Wood composites, such as fiberboard, plywood and particleboard, are vital components in the construction industry, packaging industry and in furniture manufacture. These components are engineered by using large quantity of formaldehyde-based adhesives to bond wood fibres, particles, chips and veneer sheets. However, the regulatory environment concerning the use of formaldehyde is being strengthened with new regulatory requirements coming into force in Europe, USA and China in 2015. There is therefore an urgent need to develop a new generation of ‘greener’ board with low level of formaldehyde emission. In addition to this environment issue of using formaldehyde-based adhesives, the control of using forest resources has been tightened by regulation. It was felt that growth in consumption of wood-based panels, particularly plywood, will depend increasingly on the resources of tropical forests. Therefore, it was recommended that there be more processing of logs locally in tropical forests and that integrated production be encouraged for the purpose of fuller utilization of wood. Therefore the raw wood biomaterial supplies could be stretched with the increase market needs for the wood panels, and there is an encouragement to have a through use of non-wood fibrous material where economically available.

The general steps used to produce fibreboard panels include mechanical pulping of wood chips to fibres (refining), drying, blending fibres with resin and sometimes wax, forming the resinated material into a mat, and hot pressing.

Wood chips typically are prepared onsite, logs are debarked, cut to more manageable lengths, and then sent to chippers. If necessary, the chips are washed to remove dirt and other debris. Clean chips are softened in a steam-pressurized digester, and then transported into a pressurized refiner chamber. In the refiner chamber, single or double revolving disks are used to mechanically pulp the softened chips into fibres suitable for making the board.

From the refiners, the fibres move to the drying and blending area. A rotary predryer may be used for initial drying of relatively wet furnish. Regardless of whether or not a predryer is used, tube dryers typically are used to reduce the moisture content of the fibres to desired levels. Single-stage or multiple-stage tube drying systems are commonly used in MDF manufacture. Most of the multiple-stage tubes drying systems incorporate two stages. In multiple-stage tube dryers, there is a primary tube dryer and a second stage tube dryer in series separated by an emission point such as a cyclonic collector. Heat is usually provided to tube dryers by the direct firing of propane, natural gas, or distillate oil or by indirect heating.

The sequence of the drying and blending operations depends on the method by which resins and other additives are blended with the fibres. Urea-formaldehyde (UF) resins are the most common resins used in the manufacture of MDF. Phenolic resins, melamine resins, and isocyanates such as MDI resin are also used. Some plants inject resins into a short-retention blender, while most facilities inject resin formulations into a blowline system. If resin is added in a separate blender, the fibres are first dried and separated from the gas stream by a fibre recovery cyclone, then conveyed to the blender. The fibres then are blended with resin, wax, and any other additives and conveyed to a dry fibre storage bin.

If a blowline system is used, the fibres are first blended with resin, wax, and other additives in a blowline, which is a duct that discharges the resinated fibres to the dryer. After drying, the fibres are separated from the gas stream by a fibre recovery cyclone and then conveyed to a dry fibre storage bin.

Air conveys the resinated fibres from the dry storage bin to the forming machine, where they are deposited on a continuously moving screen system. The continuously formed mat must be prepressed before being loaded into the hot press. After prepressing, some pretrimming is done. The trimmed material is collected and recycled to the forming machine.

The prepressed and trimmed mats then are transferred to the hot press. The press applies heat and pressure to activate the resin and bond the fibres into a solid panel. The mat may be pressed in a continuous hot press, or the precompressed mat may be cut by a flying cut-off saw into individual mats that are then loaded into a multiopening, batch-type hot press. Steam or hot oil heating of the press platens is common in domestic MDF plants. After pressing, the boards are cooled, sanded, trimmed, and sawed to final dimensions. The boards may also be painted or laminated. Finally, the finished product is packaged for shipment.

For particleboard or chipboard manufacturing, the process involves mixing wood particles with resin to form the mix to be pressed into a mat. Formaldehyde based resins are the best performing when considering cost and ease of use, Urea Melamine resin or phenol formaldehyde resin is used to offer water resistance. The mats are then hot-compressed under pressures and temperatures between 140° C. and 220° C. This process sets and hardens the glue. The boards are then cooled, trimmed and sanded. The particleboards can then be sold as raw board or surface improved through the addition of a wood veneer or laminate surface.

### DETAILED DESCRIPTION OF FIRST ASPECT OF THE INVENTION

One of the objectives of the invention is to develop a manufacturing process to reduce the consumption of forest wood for wood panel industry by totally or partially replacing wood biomass with non-wood fibrous biomass.

It is another objective of the invention to use non-wood fibrous biomass which contains a certain level of protein in order to enhance the bonding structure of the wood composites.

It is yet another objective of the invention to make a composite panel with a low level of formaldehyde released from the panel, due to the presence of protein in the biomass, when formaldehyde based resins or non-formaldehyde based resins are used to produce composite panels.

It is yet another objective of the invention to make bio-composites using protein-containing biomass, in combination with non-protein-containing biomass such as agriculture residues, for example straw fibres.

### Bio-Composite Material

According to a first aspect of the present invention there is provided a bio-composite material comprising a protein-containing non-wood fibrous biomass, and a crosslinking agent. The bio-composite material may additionally contain wood biomass, and/or non-protein-containing non-wood biomass.

The bio-composite is advantageously formable into panels, or boards, with properties similar to conventional wood-based fibreboard, chip board, or particle board. The bio-composite of the present invention may therefore advantageously be used to partially or wholly replace the use of virgin wood in the manufacture of fibrebroad or particle board.

According to a preferred aspect of this invention, a bio-composite material formed from a combination of non-wood fibrous biomass and wood biomass may be used to make panels such as medium-density fibreboard (MDF), high-density fibreboard (HDF), chip boards and particle boards. The panels may be formed from the material of the present invention using conventional manufacturing processes. Preferably protein-containing non-wood fibrous biomass usable in the present invention may be any non-wood biomass which contains protein levels of between 6% and 40% by weight. Preferably protein-containing non-wood fibrous biomass has a protein content of at least 6%, or 8%, or 10%, or 15% by weight and less than 20%, or 30%, or 35% by weight. The protein-containing non-wood fibrous biomass may have a lipid (oil) content of between 1% and 15% by weight. Preferably the protein-containing non-wood fibrous biomass has a lipid content of at least 1%, or 2%, or 4%, or 6% by weight and less than 8%, or 10%, or 12% by weight.

The protein content of the non-wood biomass unexpectedly and advantageously gives the bio-composite material improved adhesion properties to bind fibres in the bio-composite. It may also help to form the crosslinking network when curing agents are used to make bio-composites.

The term “fibrous” in this context means that the biomass is rich in structured fibres which contain cellulose, semi-cellulose and lignin, which may enhance the mechanical properties of the formed final products.

Particularly advantageously, one or more varieties of protein-containing non-wood biomass may be selected and incorporated into the bio-composite material to to achieve desired levels of protein and lipid in the bio-composite material.

References to percentages should in the context of this application be considered to refer to percentages by weight, or wt %, unless otherwise indicated.

In preferred embodiments of the invention, the protein-containing non-wood fibrous biomass may comprise bioethanol by-products such as Distiller's Grain (DG), or Distiller's Dry Grain and Solubles (DDGS) which contain protein levels up to 35%. The protein-containing non-wood fibrous biomass may comprise soya beans, soya bean residues after soya oil has been extracted, biodiesel residues after algal biomass has been refined, or just algal biomass, sugar beets residues after sugar has been extracted, waste coffee grounds and/or any other agricultural residue biomass which contain appropriate quantities of protein and lipid (oil).

In a particularly preferred embodiment of the present invention, the bio-composite material may comprise used coffee grounds as protein-containing non-wood fibrous biomass.

The term “used coffee grounds” refers to ground coffee beans once they have been used to make coffee. Thus used coffee grounds may alternatively be termed “recycled coffee 10 grounds” or “waste coffee grounds”.

Many millions of tons of coffee grounds are used to make coffee worldwide each day, creating huge amounts of waste material which typically ends up in landfill. The present invention may advantageously reduce this waste by providing a second use for otherwise worthless used coffee grounds once they have fulfilled their primary purpose by being used to make coffee. The present invention may advantageously reduce the quantity of virgin (non-recycled) materials used in fibreboard or particle board manufacture, by replacing virgin material with used coffee grounds.

In preferred embodiments of the invention, the crosslinking agents used to make fibreboard and chipboards may be formaldehyde base resin such as urea-formaldehyde resin, phenol-formaldehyde resin, melamine urea-formaldehyde resin, methylene diphenyl diisocyanate (MDI), polymeric methylene diphenyl diisocyanate (pMDI) or polyurethane based adhesives and any other currently used wood adhesives.

According to preferred embodiments of the invention, the bio-composite material may contain wood biomass, and/or non-protein-containing biomass, which may be non-protein-containing non-wood biomass. For example, the bio-composite material may comprise wood chips or pulped wood, or non-wood biomass such as straw fibre, bamboo fibre, sugar cane fibre, or other agricultural residues.

The bio-composite material may comprise recycled paper, card or plastic-coated paper packaging as non-protein-containing biomass.

“Non-protein-containing” non-wood biomass may be considered to be any non-wood biomass containing less than 6% protein by weight. Preferably, the “non-protein-containing” non-wood biomass may contain less than 5%, or 4.5% or 4% protein by weight. Oat, barley or wheat straw, for example, typically contain less than 4.5 wt % crude protein, so are considered to be “non-protein-containing” for the purposes of this invention.

The bio-composite material of the present invention may consist of one or more types of protein-containing non-wood fibrous biomass, and one or more cross-linking agents. Alternatively the bio-composite material may consist of, or comprise, these components in addition to wood biomass such as wood chips, and/or non-protein-containing non-wood biomass.

The bio-composite material preferably comprises protein-containing non-wood fibrous biomass in a quantity of 10-95% by weight, preferably in the range of 20-60% by weight, and most preferably in the range of 20-50% by weight.

Preferably the bio-composite material comprises at least 10%, or 15%, or 20%, or 25% by weight and less than 25%, or 60%, or 75% or 90% by weight of protein-containing non-wood fibrous biomass.The remainder of the bio-composite material, to a total of 100% by weight, preferably comprises one or more crosslinking agents, and optionally wood biomass and/or non-protein containing non-wood fibrous biomass.

For both particle boards and fibreboard, where formaldehyde based resins are used as crosslinking agents, the level of the formaldehyde based resin applied in the process may be in the range of 2-15% based on dry weight of fibre, preferably in the range of 4-12% and most preferably in the range of 4-8%. Where non-formaldehyde based resins are used as crosslinking agents, the level of the non-formaldehyde based resin such as MDI resin applied in the process may be in the range of 0.5-6% based on the dry weight of fibre, preferably in the range of 1-5%, most preferably in the range of 2-3%.

The use of the protein-containing non-wood fibrous biomass can reduce the level of formaldehyde-based resin used for the process, due to the formation of chemical bonds between the protein and formaldehyde in the bio-composite. This advantageously leads to low formaldehyde release from the bio-composite panel, and also can reduce the emission level of formaldehyde originating from the wood itself. When MDI based resin is used, such as pMDI, the bio-composite panel produced contains no added formaldehyde, which leads to very low formaldehyde emission.

Crosslinking agents may be termed resins.

Crosslinking agents (resins) suitable for use in bio-composite material for manufacture of fibreboard or particle board may include formaldehyde base resin such as urea-formaldehyde resin, phenol-formaldehyde resin, melamine urea-formaldehyde resin, non-formaldehyde based resin such as MDI or pMDI, and any other currently used non-formaldehyde wood adhesives.

For both particle boards and fibreboard, where formaldehyde based resins are used as crosslinking agents, the level of the formaldehyde based resin applied in the process may be in the range of 2-15% based on dry weight of fibre, preferably in the range of 4-12% and most preferably in the range of 4-8%. Where non-formaldehyde based resins are used as crosslinking agents, the level of the non-formaldehyde based resin such as MDI resin applied in the process may be in the range of 0.5-6% based on the dry weight of fibre, preferably in the range of 1-5%, most preferably in the range of 2-3%.

In this invention, the protein-containing non-wood fibrous biomass may include bioethanol by-products such as Distiller's Grain (DG) or Distiller's Dry Grain and Solubles (DDGS) which containing protein levels up to 35%. Other biomass includes soya bean or soya bean residues after soya oil has been extracted, algal biomass or biodiesel residues after algal biomass has been refined, sugar beets residues after sugar has been extracted and waste coffee grounds after coffee is extracted any other agricultural residue biomass which containing protein.

The protein level of the protein-containing non-wood fibrous biomass is preferably in the range of 6-40%, more preferably in the range of 6-30%, most preferably in the range of 8-20%. The lipid (oil) level is varied from 1-15%, preferably in the range of 5-12%, most preferably in the range of 6-10%. This can be achieved by selecting one of more types of such biomass to get optimised protein level and lipid level in the resulting bio-composite material.

Protein-containing fibrous biomass, such as Distiller's Grain (DG), Distiller's Dry Grain and Solubles (DDGS), soya bean, soya-bean residuals after oil being extracted, sugar beets biomass after sugar being extracted, algae, algal biomass after oil being extracted, waste coffee ground and other protein containing fibrous biomass, is partially or totally used to replace wood biomass to make biocomposites panels (such as fibreboard, chip board, or particle board) with low emission of formaldehyde from the panels. There is also provided a process to use other non-wood fibre such as straw fibre, bamboo fibre and sugar cane fibre to combine with the protein-containing fibrous biomass to be used for the manufacturing of biocomposite panels. The produced biocomposite panels can be used in the construction industry, packaging industry and automobile industry. This process can significantly or completely eliminate the use or release of formaldehyde in the panel or packaging production process. This is a considerable environmental and health benefit for people involved in the industry.

The present invention enables the replacement of expensive natural or planation sourced wood or re-cycled wood with a range of sustainable non-wood biomass types in the production of wood panels and packaging. This has the benefit of giving a more economical cost of production and environmental benefits for the conservation of natural forests. In addition it has been shown that this process can significantly or completely eliminate the use or release of formaldehyde in the panel or packaging production process this is a considerable environmental and health benefit for people involved in the industry.

The fibreboard manufacturing process may involve steam softening the wood chips and then feeding wood chips together with protein-containing non-wood fibrous biomass into a pressurized refiner chamber. In the refiner chamber, single or double revolving disks may be used to mechanically pulp the softened chips and the non-wood fibrous biomass into fibres suitable for making the board. The mixed fibres may thus consist of both wood fibres and non-wood fibrous biomass.

Thus, the manufacturing of a bio-composite panel may comprise the following steps:

For Manufacturing Particle Boards:

Mix wood chips, particles or non-wood particles such as straws with protein-containing non-wood fibrous biomass and dry to a moisture content of around 4-8%. To the blend, a cross-linking agent (resin) is added and blended, and the resulting bio-composite material is pre-pressed to form a mat formed from a bio-composite material.

The mat of bio-composite material may be formed into particleboards or chipboards using conventional hot press techniques.

In the manufacture of particle board, the proportion of protein-containing non-wood fibrous biomass in the bio-composite material may be in the range of 20-100% by weight, preferably in the range of 20-95%, or 20-60%, and most preferably in the range of 20-50%. The protein level in the biocomposite board may be in the range of 5-30% by weight, preferably in the range of 5-15%, most preferably in the range of 5-10%.

For Manufacturing Fibre Boards:

Cleaned wood chips are mixed with protein-containing non-wood fibrous biomass and the blend is softened in a steam-pressurised digester, then transported into a pressurized refiner chamber to produce fibres suitable for making the fibreboard.

Preferably the proportion of protein-containing non-wood fibrous biomass is in the range of 10-90%, preferably in the range of 20-60%, and most preferably in the range of 20-50%.

The rest of the process includes resinisation of the fibre with a crosslinking agent, fibre-drying, pre-forming the fibre mat and hot-pressing the mat to make fibreboards.

Although the invention has been described in connection with specific preferred embodiments, it should be understood that the invention as claimed should not be unduly limited to such specific embodiments, various applications of the described modes of carrying out the invention which are obvious to those skilled in the art are intended to be covered by the present invention.

The invention now will be further exemplified.

### Example 1

Protein-Containing Fibrous Biomass Based Particleboards.

In a blend, weigh into 1500 g of waste sugar beet grains after sugar process, which contains 8% protein and 10% water content. To it, 100 g of 50% solid content of ureaformaldehyde was added. After mixing, the blend was transferred into a 30×30 cm mould and press into a matrix. Then the matrix is transferred into a hot-press. The press temperature is set at 200 degrees C. for 5 minutes under 5 mPa pressure to obtain a particleboard.

### Example 2

In a blend, weigh into 1000 g of sugar beet residue after sugar processing and 500 g of DDGS particles after bioethanol processing which contains total 15% protein and 10% water content. To it, 80 g of 50% solid content of urea-formaldehyde was added. After mixing, the blend was transferred into a 30×30 cm mould and pressed into a matrix. Then the matrix is transferred into a hot-press. The press temperature is set at 200 degree C. for 5 minutes under 5 mPa pressure to obtain a particleboard.

### Example 3

In a blend, weigh into 800 g of wood particles and 500 g of DDGS particles after bioethanol processing, which contains total 15% protein and 10% water content. To it, 80 g of 50% solid content of urea-formaldehyde was added. After mixing, the blend was transferred into a 30×30 cm mould and pressed into a matrix. Then the matrix is transferred into a hot-press. The press temperature is set at 200 degree C. for 5 minutes under 5 mPa pressure to obtain a particleboard.

### Example 4

In a blend, weigh into 800 g of wood particles and 500 g of DDGS particles after bioethanol processing, which contains total 15% protein and 10% water content. To it, 10 g of MDI resin was added. After mixing, the blend was transferred into a 30×30 cm mould and pressed into a matrix. Then the matrix is transferred into a hot-press. The press temperature is set at 180 degree C. for 5 minutes under 5 mPa pressure to obtain a particleboard.

### Example 5

In a blend, weigh into 800 g of wood particles and 500 g of Algal biomass particles after biodiesel processing, which contains total 10% protein and 10% water content. To it, 80 g of 50% solid content of urea-formaldehyde was added. After mixing, the blend was transferred into a 30×30 cm mould and pressed into a matrix. Then the matrix is transferred into a hot-press. The press temperature is set at 200 degree C. for 5 minutes under 5 mPa pressure to obtain a particleboard.

### Example 6

In a blend, weigh into 800 g of straw fibre and 500 g of DDGS particles after bioethanol processing, which contains total 15% protein and 10% water content. To it, 80 g of 50% solid content of urea-formaldehyde was added. After mixing, the blend was transferred into a 30×30 cm mould and pressed into a matrix. Then the matrix is transferred into a hot-press. The press temperature is set at 200 degree C. for 5 minutes under 5 mPa pressure to obtain a particleboard.

### Example 7

In a blend, weigh into 800 g of straw fibre and 500 g of DDGS particles after bioethanol process, which contains total 15% protein and 10% water content. To it, 10 g of MDI resin was added. After mixing, the blend was transferred into a 30×30 cm mould and pressed into a matrix. Then the matrix is transferred into a hot-press. The press temperature is set at 180 degree C. for 5 minutes under 5 mPa pressure to obtain a particleboard.

### Example 8

In a blend, weigh into 500 g of straw fibre and 500 g of waste coffee grounds from local coffee shop, which contains total 10% protein and 5% coffee oil. To it, 10 g of PMDI resin was added. After mixing, the blend was transferred into a 30×30 cm mould and pressed into a matrix. Then the matrix is transferred into a hot-press. The press temperature is set at 180 degree C. for 5 minutes under 5 mPa pressure to obtain a coffee ground based particleboard.

### Exampe 9

In a blend, weigh into 200 g of straw fibre and 800 g of waste coffee grounds from local coffee shop, which contains total 10% protein and 5% coffee oil. To it, 20 g of PMDI resin was added. After mixing, the blend was transferred into a 30×30 cm mould and pressed into a matrix. Then the matrix is transferred into a hot-press. The press temperature is set at 180 degree C. for 5 minutes under 5 mPa pressure to obtain a coffee ground based particleboard.

### Example 10

### Fibreboard Manufacturing

Transfer 10 kg clean wood chips and transferred into a steam pressure cooker to cook for one hour to obtain soften wood chips. Transfer the soften wood chips into a wood fibre refining equipment and 3 kg DDGS containing 30% protein was added to mix to obtain 10 kg fibres. The fibres were mixed with 200 g MDI and dry to water content at 8%. The refinished fibre was transferred to a 1×1 m mould and pressed into a matrix. Then the matrix is transferred into a hot-press. The press temperature is set at 180 degree C. for 5 minutes under 5 mPa pressure to obtain fibreboard.

### Formaldehyde Test Results

According to CARB formaldehyde limit test standard, all above samples have been tested and they meet the formaldehyde releasing level below 0.5 ppm. In those samples using MDI resin, the formaldehyde level is un-detectable.

### Preferred Feature Clauses—First Aspect

1. A bio-composite panel is manufactured using protein-containing fibrous biomass together with a wood adhesive.

2. The biocomposite panel in clause 1 is a particleboard, chipboard or a fibreboard.

3. The protein-containing fibrous biomass in the bio-composite panel in clause 1 has the weight percentage range from 20-100%. The rest composition consists a wood biomass.

4. The weight ratio of protein-containing non-wood fibrous biomass used in clausel is at the range of 20-100%, preferably in the range of 20-60%, and most preferably in the range of 20-50%. The rest composition consists a nonwood biomass.

5. The non-wood biomass in clause 4 is agricultural residue include straw fibres, sugar cane fibres and bamboo fibres.

6. The protein-containing fibrous biomass in clause 1 is distiller's grain (DG), DDGS, sugar beet residual, soya bean, soya bean residue, waste coffee ground, and algal biomass.

7. The protein level in the biocomposite board in clause 1 is in the range of 5-30%, preferably in the range of 5-15%, most preferably in the range of 5-10%.

8. The protein-containing biomass in clause 1 can be one or a combination of more of biomass as described in clause 6.

9. The wood adhesive used in clause 1 includes formaldehyde base wood adhesives.

10. The wood adhesive in clause 1 is a urea-formaldehyde resin, phenolformaldehyde resin and melamine urea-formaldehyde resin.

11. The wood adhesive in clause 1 is a non-formaldehyde based resin.

12. The wood adhesive in clause 11 is MDI and PMDI.

13. The wood adhesive used in clause 1 is in the range of 0.5-10% of the biocomposite.

14. The biocomposite panel in clause 1 has low formaldehyde level to meet CARB II, E0 and no-added formaldehyde board standard.

15. The bio-composite panel can be used in green-building construction industry.

16. The bio-composite panel can be used for building insulation.

17. The bio-composite panel can be used for food and medical packaging.

18. The bio-composite panel can be used for automobile industry.

### SECOND ASPECT OF THE INVENTION

### Manufacture Process of Biocomposite from Plastic Lined Paper Packaging Waste

A second aspect of the invention provides a biocomposite manufactured using protein-containing fibrous biomass and disposable drinking cups waste. This biocomposite can be used to produce panels and other moulded products to solve the recyclability of abundant drinking cups waste for applications in construction industry, packaging industry and automobiles industry.

### BACKGROUND—SECOND ASPECT OF THE INVENTION

Paper packaging lined with plastics to prevent liquid leakage is widely used in our daily life. For example, billions of take away coffee cups are used globally every year. However, only one in 400 coffee cups are recycled at this moment because they are made of a difficult-to-recycle mix of paper and plastic. This is the same case as those plastic lined-up paper packaging for beverage and food. It would be highly environmentally desirable to re-use this material, rather than consigning it directly to landfill.

As described in relation to the first aspect of the invention, above, wood-based composites, such as fibreboard, plywood and particleboard, are vital components in the construction industry, packaging industry and in furniture manufacture.

### DETAILED DESCRIPTION OF SECOND ASPECT OF THE INVENTION

One of objectives of this invention is to develop a simple manufacturing process to have a better use of paper-plastic packaging waste, and to reduce the consumption of forest wood for the wood panel industry.

According to second aspect of the present invention there is provided a bio-composite material comprising paper-plastic packaging waste. Such packaging waste may include waste from take-away coffee cups, cold drink cartons and any other paper packaging with plastic lining.

According to a preferred embodiment, the bio-composite material may be a bio-composite material as described in relation to the first aspect of the invention, above. Preferably, paper-plastic packaging waste may take the place of the non-protein-containing biomass component of the bio-composite material.

According to a preferred embodiment of the invention, the paper-plastic packaging waste may be milled directly into a fibres/plastics composite material which can be used to make panels including MDF, HDF and particle boards using existing wood panel manufacturing process or moulding process.

The fibreboard manufacturing process described above in relation to the first aspect of the invention may include the step of breaking down and milling paper-plastic packaging waste (which may be cup waste) and then adding it to the bio-composite material of the first aspect. The milled packaging waste is preferably added to the blend at the resination point where the protein-containing non-wood fibrous biomass is mixed for making the board.

In a preferred embodiment of the invention, the protein containing non-wood fibrous biomass include bioethanol by-products such as Distiller's Grain (DG), Distiller's Dry Grain and Solubles (DDGS) which containing protein levels up to 35%. Other biomass includes soya bean residues after soya oil has been extracted, biodiesel residues after algal biomass has been refined, sugar beets residues after sugar has been extracted and any other agricultural residue biomass which contains protein.

In a particularly preferred embodiment, the protein-containing non-wood fibrous biomass may be used coffee grounds.

In preferred embodiments of the invention, the resins used to make fibreboard and particle-boards may be formaldehyde base resin such as urea-formaldehyde resin, phenol-formaldehyde resin, melamine urea-formaldehyde resin, MDI and any other currently used wood adhesives.

The combination of the protein-containing non-wood fibrous biomass can reduce the level of formaldehyde-based resin used for process, due to the formation of chemical bonds between the protein and formaldehyde in the bio-composite, which leads to low formaldehyde release and also can reduce the emission level of formaldehyde originated from the wood itself. When MDI based resin is used, the wood panel produced has very low level of emission of formaldehyde.

Thus, the manufacturing of a bio-composite panel according to the second aspect of the invention may comprise the following steps:

Manufacturing Particle Boards:

Plastic-lined paper cup waste is milled using standard mechanical milling machine to obtain a fibre size of 5 mm-20 mm, ready for board manufacturing. Mix the above fibre particles with protein-containing non-wood fibrous biomass and to the blend, resins are added and blended into a bio-composite material. The bio-composite material is pre-pressed to form a mat, transferred into a hot press, and pressed to produce particleboards or chipboards.

Preferably in the particle board manufacturing process, the weight ratio of protein-containing non-wood fibrous biomass is at the range of 10-50%, preferably in the range of 10-30%, and most preferably in the range of 10-20%.

Manufacturing Fibre Boards:

Step 1: Cleaned paper-plastic packaging waste is mixed with protein-containing non-wood fibrous biomass and the blend is softened in a steam-pressurised digester, then transported into a pressurized refiner chamber to produce fibres suitable for making the fibreboard.

Preferably in step 1 the proportion of protein-containing non-wood fibrous biomass is in the range of 10-50%, preferably in the range of 10-30%, and most preferably in the range of 10-20%.

Step 2: The rest of process includes resinisation of the fibre with crosslinking material (resin), fibre-drying, pre-forming the fibre mat and hot-pressing to make fibreboards.

As described in relation to the first aspect of the invention, the resin used in the panel processing may includes formaldehyde based resin such as urea-formaldehyde resin, phenol-formaldehyde resin, melamine-urea-formaldehyde resin, non-formaldehyde based resin such as MDI and any other currently used nonformaldehyde wood adhesives.

For both particle boards and fibreboard, where formaldehyde based resin is used as crosslinking material, the level of the formaldehyde based resin applied in the process is in the range of 2-15% based on dry weight of fibre, preferably in the range of 4-12% and most preferably in the range of 4-8%.

Where non-formaldehyde based resin is used as crosslinking material, the level of the non-formaldehyde based resin such as MDI resin applied in the process is in the range of 0.5-6% based on the dry weight of fibre, preferably in the range of 1-5%, most preferably in the range of 2-3%.

According to preferred embodiments of the invention, the protein containing non-wood fibrous biomass include bioethanol by-products such as Distiller's Grain (DG) or Distiller's Dry Grain and Solubles (DDGS) which containing protein levels up to 35%. Other biomass includes soya bean residues after soya oil has been extracted, biodiesel residues after algal biomass has been refined or just raw algal biomass, sugar beets residues after sugar has been extracted, used coffee ground and any other agricultural residue biomass which containing protein. The protein level of the non-wood fibrous biomass is in the range of 5-40%, preferably in the range of 5-30%, most preferably in the range of 5-20%. This can be achieved by select one of more of such biomass to get optimised protein level for this invention.

The invention now will be further exemplified.

### Example 1

Plastic Lined Paper Cup Waste Based Particleboards

In a blend, weigh into 1500 g of used coffee cups, which were milled into fine fibres (5 mm-10 mm), to it, 150 g of DDGS powder was added to have a good mix. Then, 100 g of 50% solid content of urea-formaldehyde was added. After mixing, the blend was transferred into a 30×30 cm mould and press into a matrix. Then the matrix was transferred into a hot-press. The press temperature was set at 200 degree C. for 5 minutes under 5 mPa pressure to obtain a particleboard.

For comparison, in a blend, weigh into 1500 g of used coffee cups, which have been milled into fine fibres (5 mm-10 mm), To it, 100 g of 50% solid content of ureaformaldehyde was added. After mixing, the blend was transferred into a 30×30 cm mould and press into a matrix. Then the matrix was transferred into a hot-press. The press temperature was set at 200 degree C. for 5 minutes under 5 mPa pressure to obtain a particleboard.

### Example 2

In a blend, weigh into 800 g of used coffee cups fibres and 500 g of DDGS particles after bioethanol process, which contains total 15% protein and 10% water content. To it, 10 g of MDI resin was added. After mixing, the blend was transferred into a 30×30 cm mould and press into a matrix. Then the matrix is transferred into a hotpress. The press temperature is set at 180 degree C. for 5 minutes under 5 mPa pressure to obtain a particleboard.

### Example 3

In a blend, weigh into 800 g of used coffee cup fibres and 500 g of Algal biomass particles collected from lake, which contains total 10% protein and 10% water content. To it, 80 g of 50% solid content of urea-formaldehyde was added. After mixing, the blend was transferred into a 30×30 cm mould and press into a matrix. Then the matrix is transferred into a hot-press. The press temperature is set at 200 degree C. for 5 minutes under 5 mPa pressure to obtain a particleboard.

### Example 4

In a blend, weigh into 800 g of used fruit drink cartoon fibre and 200 g of DDGS particles after bioethanol process, which contains total 30% protein, 6% lipid and 10% water content. To it, 10 g of MDI resin was added. After mixing, the blend was transferred into a 30×30 cm mould and press into a matrix. Then the matrix is transferred into a hot-press. The press temperature is set at 180 degree C. for 5 minutes under 5 mPa pressure to obtain a particleboard.

### Example 5

### Fibreboard Manufacturing

Transfer 10 kg clean used coffee cups and transferred into a steam pressure cooker to cook for one hour to obtain soften cups. Transfer the soften cups into a wood fibre refining equipment and 3 kg DDGS containing 30% protein was added to mix to obtain 10 kg fibres. The fibres were mixed with 200 g MDI and dry to water content at 8%. The refinished fibre was transferred to a 1×1 m mould and press into a matrix. Then the matrix was transferred into a hot-press. The press temperature was set at 180 degree C. for 5 minutes under 5 mPa pressure to obtain fibreboard.

### Formaldehyde Test Results

According to CARB formaldehyde limit test standard, all above samples have been tested and they meet the formaldehyde releasing level below 0.3 ppm. In those samples using MDI resin, the formaldehyde level is un-detectable.

The present invention enables the replacement of expensive natural or plantation sourced wood or re-cycled wood with used coffee cups and other plastic-lined paper packaging. In addition, a range of sustainable non-wood biomass can be added to enhance the adhesion of the formed biocomposites. This has the benefit of giving a more economical cost of production and environmental benefits for the conservation of natural forests and improve the recyclability of coffee cups waste for instance. In addition it has been shown that this process can significantly or completely eliminate the use or release of formaldehyde in the panel or packaging production process. This is a considerable environmental and health benefit for people involved in the industry.

### Preferred Feature Clauses—Second Aspect

1. A biocomposite is manufactured using plastic lined up packaging waste, together with a protein-containing fibrous biomass and a wood adhesive.

2. The biocomposite in clause 1 is a particleboard or fibreboard or a moulded object by hot press.

3. The plastic lined up paper packaging waste include take away beverage and food packaging.

4. The weight ratio of protein-containing non-wood fibrous biomass used in clausel is at the range of 10-50%, preferably in the range of 10-40%, and most preferably in the range of 10-20%.

5. The protein-containing fibrous biomass in clause 1 is distiller's grain (DG), DDGS, sugar beet residual, soya bean residue, used coffee ground, algal biomass.

6. The protein level in the biomass in clause 1 is in the range of 5-40%, preferably in the range of 5-30%, most preferably in the range of 5-20%.

7. The protein-containing biomass in clause 1 can be one or a combination of more of biomass as described in clause 6.

8. The wood adhesive used in clause 1 includes formaldehyde base wood adhesives.

9. The wood adhesive in clause 1 is a urea-formaldehyde resin, phenolformaldehyde resin and melamine urea-formaldehyde resin.

10. The wood adhesive in clause 1 is a non-formaldehyde based resin.

11. The wood adhesive in clause 10 is MDI and PMDI.

12. The wood adhesive used in clause 1 is in the range of 0.5-15% of the biocomposite.13. The biocomposite panel in clause 1 has low formaldehyde level to meet CARB II standard.

14. The bio-composite panel can be used in green-building industry.

15. The bio-composite panel can be used for building insulation.

16. The bio-composite panel can be used for food and medical packaging.

17. The bio-composite panel can be used for transportation industry.

### THIRD ASPECT OF THE INVENTION

### Bioplastics, Manufactured Using Bioadhesive and Plant Fibrous Biomass, and Their Uses

A third aspect of the invention provides a bioplastic material manufactured using a bio-adhesive that is reinforced protein- and lipid-containing natural fibrous biomass, in addition to plant fibers, to blend with plastics. This process avoids complex thermal and chemical modifications and pre-treatments and can be used to manufacture a wide range of bioplastics in a cost-efficient and environmentally sustainable manner. The bioplastics produced can be used as direct substitutes for common plastic polymers in a wide variety of industrial applications.

### BACKGROUND—THIRD ASPECT OF THE INVENTION

Oil-based plastic polymers are an essential part of modern society, with applications in almost every industrial sector. Currently only a small part of the plastics produced are bio-based, as bio-based polymers usually bear a higher cost than the competing fossil-based alternatives. Also, current bio-based plastics on the market do not offer a large enough functional improvement to justify a premium price. Therefore, there has been considerable interest in the development and use of more environmentally friendly alternatives to oil based plastics and this has prompted exploration of the use of wood or plant based fibers as additives to plastics and polymers as a way of reducing oil use and the environmental damage done. These plant fiber-reinforced polymers have found use in a number of industrial sectors to replace part of the plastics.

Biodegradability, compostability and recyclability of bio-based plastics may offer a significant added value in terms of sustainability. However, associated performance and costs still hinder the full marketability and competitiveness of biodegradable, compostable or recyclable bio-based plastics compared with their fossil-based counterparts. However, there is a specific challenge to develop biodegradable, compostable or recyclable bio-based polymers that can compete with fossil-based counterparts in terms of price, performance and environmental sustainability on a cradle-to-cradle basis.

In this invention, a bioadhesive that is reinforced fibrous biomass containing protein and lipid has been used in addition to plant fibers to make bio-based plastic in which the biomass content can be incorporated into standard plastic materials at high level to solve above challenges associated with bio-based polymers.

### DETAILED DESCRIPTION OF THIRD ASPECT OF INVENTION

One of the objectives of the invention is to develop a bioplastics using a bioadhesive that is reinforced with fibrous biomass containing protein and lipid, in addition to plant fibers to replace part of plastics.

It is another objective of the invention to use the above bioadhesive to enhance the compatibility between the plastic and the cellulose fibre, in order to have a high level of biomass incorporation without jeopardising the mechanical properties of the final products and processability of the composites using existing moulding equipment.

It is yet another objective of the invention to make bioplastics with varied properties when different sources of fibrous biomass are used.

According to a third aspect of the invention, there is provided a bioplastic material comprising a protein-containing fibrous biomass, a plastic (or polymer) material, and a bioadhesive.

The bioplastic material may advantageously be formable into a desired shape by conventional plastic processing techniques, and has mechanical properties similar to conventional plastic materials. The bioplastic of the present invention may therefore advantageously reduce the environmental impact of plastic materials by partially replacing virgin plastic content with protein-containing fibrous biomass.

In this aspect of the invention, the bioadhesive comprises reinforced fibrous biomass containing protein and lipid.

Suitable bioadhesive may be bioadhesive manufactured from Distiller's Grain (DG), Distiller's Dry Grain and Solubles (DDGS), Algae and/or other biomass which contains cellulose, protein and lipid as raw materials.

Preferably the bioadhesive may be a bio-resin provided by Cambond Ltd.

Suitable bioadhesives, and methods of forming such bioadhesives, are described in CN103725253B and WO2015104565A2.

Bioadhesive may advantageously enhance the compatibility between biomass and plastics to save the cost to treat fibres as fillers. This can lead to a higher percentage of biomass incorporated into the bioplastic. The formed bioplastics still have good mechanical properties.

The protein level in the bioadhesive (Cambond bio-resin) may be in the range of 6-40% by weight, preferably in the range of 6-30%, most preferably in the range of 8-20%. This can be achieved by selecting one of more types of biomass to get optimised protein level for this invention.

The lipid level in the bioadhesive (Cambond bio-resin) may be in the range of 2-15% by weight, preferably in the range of 2-10%, most preferably in the range of 2-8%. This can be achieved by selecting one of more types of biomass to get optimised lipid level for this invention.

The bioadhesive is preferably processed with other additives into fine dry powder form (mesh size 40-400 mesh size, Cambond bio-resin), as described in CN103725253B, and WO2015104565A2.

In order to form a bioplastic, the bioadhesive is mixed with plastics in addition to other natural plant fibres to make bioplastic compound pellets. Other process plastic additives can be added to improve the appearance, process flow-ability, anti-thermal and light degradation during the process and daily use.

According to a preferred embodiment of the invention, the bioadhesive is Cambond bioadhesive based on Distiller's Grain (DG), and/or Distiller's Dry Grain and Solubles (DDGS) which contain protein levels up to 35% and lipid up to 10%, as described in CN103725253B, and WO2015104565A2.

The additional plant fibres may include used coffee bean grounds, soya bean fibres after soya bean is processed into beverage or oil, sugar beets residues after sugar has been extracted and/or any other plant fibers (fibrous biomass).

Preferably, the plant fibres used in the third aspect of the invention may be “protein-containing non-wood fibrous biomass” or “non-protein-containing non-wood fibrous biomass” as described and defined above in relation to the first aspect of the invention. Features of the “protein-containing” or “non-protein-containing” non-wood fibrous biomass described in relation to the first aspect are equally applicable to the fibrous biomass used in the third aspect of the invention.

The plastic component of the bioplastic material may be a “virgin” (or newly-manufactured) plastic. Alternatively, recycled plastic may be used as the plastic component of the bioplastic material.

According to the third aspect of the, the plastics used to make the bioplastics may be one or more thermoplastic or thermosetting plastic materials.

Where the bioplastic contains non-biodegradable thermoplastic or thermosetting polymer, the bioplastic material may advantageously be recyclable.

Where the bioplastic contains biodegradable thermoplastic or thermosetting polymer, the bioplastic material may advantageously be recyclable and biodegradable.

Suitable thermoplastics may include polypropylene, polyethylene (low density and high density), polystyrene, polyvinyl chloride and thermo-plastic polyurethane, acrylonitrile butadiene styrene (ABS), and fully biodegradable polymers such as PLA, PGA or their copolymer, or any other biodegradable polymers such as Polyhydroxy(butyrate-co-valerate) (PHBV), poly(butylene succinate) (PBS), poly(butylene adipate-co-terephatalate) (PBAT), polyhydroxy(butyrate-co-valerate)/poly(butylene succinate), (PHBV/PBS) blend and PBAT/PHBV blend, which is suitable for injection, extrusion blowing and compress moulding.

Bioplastics formed from thermoplastic material and fibrous biomass may advantageously be suitable for injection, extrusion, blow moulding and compress moulding.

Suitable thermo-setting polymers, or “pre-polymers” may include formaldehyde-based resin such as phenol-formaldehyde resin, urea-formaldehyde resin, or Melamine resin, MDI resin and/or any natural and synthetic rubber, which can be cured during processing to form a moulded thermo-setting end product.

Bioplastics formed from thermo-setting plastic material and fibrous biomass may advantageously be curable under heat to form a thermo-set bioplastic material.

The proportion of bioadhesive (Cambond bio-resin) in the bioplastic material may be in the range of 10-60% by weight, preferably in the range of 10-50%, and most preferably in the range of 20-40%.

The proportion of additional plant fibres, or fibrous biomass, in the bioplastic material may be in the range of 10-60% by weight, preferably in the range of 10-50%, and most preferably in the range of 10-30%.

In addition to bioadhesive and additional plant fibres, the remainder of the bioplastic material is preferably polymer, and optionally polymer process additives, to make the bioplastic up to 100% by weight.

The protein level in the bioplastic material may be in the range of 5-30%, preferably in the range of 5-20%, most preferably in the range of 5-10%.

The bioplastic may comprise 30-60% by weight thermoplastic plastic material, preferably in the range of 30-50%, and most preferably in the range of 10-30 wt %.

For a thermo-setting bioplastic containing formaldehyde-based resin and/or melamine resin as the thermo-setting plastic material, the level of the formaldehyde based resin and/or melamine resin applied in the process may be in the range of 2-40% based on dry weight of total biomass fibres, preferably in the range of 4-30% and most preferably in the range of 10-30%.

Where non-formaldehyde-based resin is used as the thermo-setting plastic material, the proportion of the non-formaldehyde based resin, such as MDI resin, applied in the process is in the range of 0.5-6% based on the dry weight of fibre, preferably in the range of 1-5%, most preferably in the range of 2-3%.

The bioplastic is produced using a bioadhesive that is reinforced protein and lipid containing fibrous biomass, in addition to a plant fibre such as used coffee bean ground, used soya bean ground and other agricultural waste fibres, and a virgin polymer with existing standard polymer process manufacturing equipment. The bioplastic produced can be used to make consumable products such as reusable cups and products in other industrial sectors, i.e. packaging, construction, transportation, and automobile industry. The invented bioplastic can significantly reduce the use of oil-based plastics for sustainability, circular economy and green industry.

The manufacturing of bioplastics may comprise the following steps:

For Thermo-Plastics Based Bioplastics:

The process of manufacturing thermoplastic-based bioplastic may comprise the following steps:

Mix thermoplastic virgin polymer 30-60% by weight, 10-60% bioadhesive (Cambond bio-resin) and 10-60% plant fibres to make up to 100%. Other conventional polymer process additives may also be added to the blend, such as pigments, anti-UV oxidants, lubricants, and tougheners if it is required.

The blend is pelletised using a standard twin-screw extrusion equipment to obtain bioplastic pellets.

Bioplastic based products may be formed from the above formulated bioplastic compounding pellets with injection moulding, and/or blowing moulding equipment.

Various products can be formed from the bioplastic, such as re-useable coffee cups to replace disposable paper cups, containers, coat hangers, plates for plantation, pots for gardening.

For Thermo-Setting Based Bioplastic:

Mix bioadhesive (Cambond Bio-resin), plant fibres and thermo-setting pre-polymers, and place the mixture into a hot press-moulding equipment or a vacuum press machine.

The mixture may then be formed into thermo-set bioplastic using conventional hot press or vacuum press techniques.

The proportion of bioadhesive (Cambond bio-resin) may be in the range of 10-60% by weight, preferably in the range of 10-50%, and most preferably in the range of 20-40%. The proportion of plant fibres may be in the range of 10-60% by weight, preferably in the range of 10-50% and most preferably in the range of 10-30%. The remainder is preferably the thermo-setting pre-polymer to make up to 100%.

The thermo-setting pre-polymers used in the process may include formaldehyde based resin such as urea-formaldehyde resin, phenol-formaldehyde resin, melamine urea-formaldehyde resin, melamine resin, and non-formaldehyde based resin such as MDI and any other currently used non-formaldehyde wood adhesives.

The invention now will be further exemplified.

### Example 1

In a blend, weigh into 10 kg of used coffee ground, which were milled into fine biomass, to it, 40 kg of DDGS-based bioadhesive (CAMBOND bio-resin powder as described in WO2015104565A2, manufactured by Cambond JVC company, CamTian New Materials Co., Ltd), was added to have a good mix. Then, 50 kg of polypropylene pellets was added and blended. After mixing, the blend was transferred into a twin-screw extruder to make pellets.

The pellets can be used to make reusable coffee cups.

### Example 2

In a blend, weigh into 20 kg of used coffee ground, which were milled into fine biomass, to it, 30 kg of Algae-based bioadhesive (CAMBOND bio-resin powder as described in WO2015104565A2, manufactured by Cambond JVC company, CamTian New Materials Co., Ltd), was added to have a good mix. Then, 50 kg of polypropylene pellets was added and blended. After mixing, the blend was transferred into a twin-screw extruder to make pellets.

The pellets can be used to make reusable coffee cups.

### Example 3

In a blend, weigh into 10 kg of soya fibres after soya bean is processed into soya based drink, which were milled into fine biomass, to it, 40 kg of DDGS-based bioadhesive (CAMBOND bio-resin powder as described in WO2015104565A2, manufactured by Cambond JVC company, CamTian New Materials Co., Ltd), was added to have a good mix. Then, 50 kg of polypropylene pellets was added and blended. After mixing, the blend was transferred into a twin-screw extruder to make pellets. The pellets can be used to make reusable beverage drinking bottles and containers.

### Example 4

In a blend, weigh into 20 kg of wheat straw fibres, which were milled into fine biomass, to it, 30 kg of Algae-based bioadhesive (CAMBOND bio-resin powder as described in WO2015104565A2, manufactured by Cambond JVC company, CamTian New Materials Co., Ltd), was added to have a good mix. Then, 50 kg of PLA pellets was added and blended. After mixing, the blend was transferred into a twin-screw extruder to make pellets. The pellets can be used to make reusable and fully biodegradable beverage drinking bottles and containers.

### Preferred Feature Clauses—Third Aspect

1. A bioplastic is manufactured using a bioadhesive, in addition to natural plant fibers and a thermoplastic and thermo-setting polymer.

2. The bio-adhesive in clause 1 that is reinforced protein and lipid containing biomass.

3. The bioadhesive in clause 1 is reinforced protein containing biomass from distiller's grain (DG), DDGS and algal biomass.

4. The protein and lipid containing biomass in clause 2 can be one or a combination of more of biomass as described in clause 3.

5. The additional plant fibres in clause 1 are used coffee bean ground, soya bean ground and any of other agricultural waste plant fibres.

6. The thermoplastics in clausel is polypropylene, polyethylene (low density and high density), polystyrene, polyvinyl chloride, and thermo-plastic polyurethane, acrylonitrile butadiene styrene (ABS), and fully biodegradable polymers such as PLA, PGA or their copolymer, or any other biodegradable polymers such as Polyhydroxy(butyrate-co-valerate) (PHBV), poly(butylene succinate) (PBS), poly(butylene adipate-co-terephatalate) (PBAT), polyhydroxy(butyrate-co-valerate)/poly(butylene succinate), (PHBV/PBS) blend and PBAT/PHBV blend, which is suitable for injection, extrusion blowing and compress moulding.

7. The thermo-setting polymer in Clause 1 is any thermo-setting polymers including phenol-formaldehyde resin, urea-formaldehyde resin, Melamine resin and any natural and synthetic rubber, which can be cured during process to form a moulded thermo-setting end product.

8. The weight ratio of Cambond bio-resin of in clausel is at the range of 10-60%, preferably in the range of 10-50%, and most preferably in the range of 20-40%.

9. The weight ratio of additional plant fibres of in clausel is at the range of 10-60%, preferably in the range of 10-50%, and most preferably in the range of 10-30%. The rest of part is polymer with and without polymer process additives to make up to 100%.

10. A bioplastic in clause 1 is recyclable when a non-biodegradable thermoplastic or thermosetting polymer is used.

11. A bioplastic in clause 1 is both recyclable and biodegradable when a biodegradable polymer is used.

12. A bioplastic in clause 1 can be used for all production and manufacturing methods to produce products for consumables, agricultural and other industrial sectors.

13. The consumable products in clause 12 include re-usable cups and other tablewares.

14. The consumable products in clause 12 include a coat hanger.

15. The agricultural products in clause 12 include pots and plates for plantation.

16. The other industrial sectors include construction, automobiles, logistics and packaging industry.

### CUP AND METHOD

According to a fourth aspect of the present invention there is provided a cup formed from bioplastic, and a method of manufacturing cups from bioplastic. In a further aspect of the invention, the present invention may relate to linking consumer products such as coffee cups with personal information relating to a user or owner, in particular information linking consumer products to the environmental and personal information of their owners.

### BACKGROUND

Single-use cups, particularly single-use coffee cups, are relatively environmentally unfriendly. Millions of such cups are sold as “disposable” products by coffee shops around the world each day, but these cups are rarely recycled as a result of the polyethylene-infused material from which coffee cups are conventionally made. Furthermore, coffee cups are almost always made from virgin paper pulp, to prevent leakage from the seam of card that comes into contact with the liquid contents of the cup.

It would be desirable to provide a more environmentally-friendly coffee cup, in order to reduce the carbon footprint of these everyday products.

Consumers are becoming more conscious of the environmental damage and the carbon costs resulting from the manufacture and use of consumer products. There is an increasing need and desire to improve the environmental qualities of consumer products and to inform product users of the environmental and carbon costs and consequences of product use.

The variety in size and shape of consumer products makes the provision of environmentally linked information a problem. At present there is no system to link the use of a consumer product to the product owner's environmental and personal goals. By linking the owner's use of a product to specific environmental information an individual can be empowered to alter their behavior and use of products to optimise their environmental choices and achieve their environmental goals.

### FOURTH ASPECT OF THE INVENTION

The fourth aspect of the invention provides a coffee cup, as defined in the appended independent claims to which reference should now be made. Preferred or advantageous features of the invention are set out in dependent sub-clauses.

A fourth aspect of the present invention may thus provide a cup formed from a bioplastic material, in which the bioplastic material comprises used coffee grounds.

In a particularly preferred embodiment, the cup may be a coffee cup.

Preferably the cup may consist entirely of bioplastic.

Preferably the cup may be formed from bioplastic according to the third aspect of the invention, described above. Features described in relation to the third aspect of the invention may be equally applicable to the bioplastic material of the fourth aspect.

The term “used coffee grounds” refers to ground coffee beans once they have been used to make coffee. Thus used coffee grounds may alternatively be termed “recycled coffee grounds” or “waste coffee grounds”.

Many millions of tons of coffee grounds are used to make coffee worldwide each day, creating huge amounts of waste material which typically ends up in landfill. The present invention may advantageously reduce this waste by providing a second use for otherwise worthless used coffee grounds once they have fulfilled their primary purpose by being used to make coffee. The present invention may advantageously reduce the quantity of virgin (non-recycled) materials, whether plastics and/or paper pulp, used in cup manufacture, by replacing virgin material with used coffee grounds.

The cup is preferably biodegradable, compostable, and/or recyclable.

The cup may be any shape suitable for containing liquids. For example, the cup may be handle-less, or may comprise a handle. Preferably the cup may be a cylindrical or frusto-conical cup with no handle.

The cup is preferably able to withstand high temperatures without deforming, so that it is suitable for containing hot liquids such as coffee.

The bioplastic material may advantageously have a low thermal conductivity, so that hot contents of the cup stay warm, and the cup is not too hot to the touch when it contains hot liquids. This may advantageously make the cup suitable for use as a coffee cup.

The bioplastic material may be a thermosetting bioplastic material. In this case, once the bioplastic material has been formed into a cup, it does not soften when heated, and it is not capable of being reshaped. Such a material may advantageously be suitable for containing hot liquids.

Alternatively the bioplastic material may be a thermoplastic bioplastic material. In this case the cup may soften when subjected to elevated temperatures. Preferably the cup may withstand temperatures of at least 100 C, or at least 120 C, or at least 150 C without deforming. Even a thermoplastic bioplastic cup may therefore be suitable for containing hot liquids, so that it is suitable for use as a coffee cup.

Preferably the bioplastic material comprises between 10% and 60% used coffee grounds by weight. The bioplastic material may comprise between 10% and 50%, or between 20% and 40% used coffee grounds by weight.

The bioplastic may comprise a bioadhesive material. Preferably the bioadhesive is manufactured using Distiller's Grain (DG), Distiller's Dry Grain and Solubles (DDGS), Algae or other biomass which contains cellulose, protein and lipid as raw materials. Using a bioadhesive may further reduce the carbon footprint of the bioplastic material, and the cup itself, compared to synthetic plastics or other adhesives.

Preferably the bioplastic material may comprise between 10% and 60%, or between 10% and 50%, or between 10% and 40% bioadhesive by weight.

Manufacturing cups from bioplastic may make such cups significantly more environmentally friendly than cups formed from 100% virgin plastic or the like, and helps individual consumers achieve their environmental goals and aims.

In a preferred embodiment, the cup may comprise one or more machine-readable indicia printed or embossed on an outer surface of the cup. The machine-readable indicia may be usable as part of an information delivery system, as described further below.

### FIFTH ASPECT OF THE INVENTION

A fifth aspect of the invention may advantageously provide a method of forming a cup from a thermoplastic bioplastic material comprising the steps of injection moulding or blow moulding a thermoplastic bioplastic material to form a cup.

The method may comprise the additional first step of manufacturing a thermoplastic bioplastic material by: mixing thermoplastic polymer, bioadhesive, and used coffee grounds, to form a mixture; and extruding the mixture to form bioplastic pellets suitable for injection moulding or blow moulding.

The thermoplastic polymer may be virgin thermoplastic polymer.

The blend may be pelletised using conventional twin-screw extrusion equipment to obtain the bioplastic pellets. The bioplastic pellets may also contain other polymer process additives such as pigments, anti-UV oxidants, lubricants, and tougheners if it is required.

Preferably the mixture comprises: 30% to 60% thermoplastic polymer by weight; 10% to 60% bioadhesive by weight; and 10% to 60% used coffee grounds by weight. In total, the components of the mixture must add up to 100% by weight.

### SIXTH ASPECT OF THE INVENTION

A sixth aspect of the invention, may advantageously provide a method of forming a cup from a thermosetting bioplastic material comprising the steps of: hot-press moulding or vacuum pressing a thermosetting bioplastic material to form a cup.

The method may comprise the additional first step of manufacturing a thermosetting bioplastic material by: mixing thermosetting pre-polymer, bioadhesive, and used coffee grounds, to form a mixture.

The mixture may be extruded into pellets suitable for hot press-moulding or vacuum pressing.

Preferably the mixture comprises:

10% to 60% bioadhesive by weight;

10% to 60% used coffee grounds by weight; and

in which the balance consists of thermosetting pre-polymer.

The thermosetting pre-polymers used in the process may include formaldehyde base resin such as urea-formaldehyde resin, phenol-formaldehyde resin, melamine urea-formaldehyde resin, melamine resin, and non-formaldehyde based resin such as MDI and any other currently used non-formaldehyde wood adhesives.

### SEVENTH ASPECT OF THE INVENTION

An seventh aspect of the invention may advantageously provide an information delivery system comprising: one or more machine readable indicia printed or embossed or moulded or otherwise coupled to an outer surface of the product; wherein the machine readable indicia is configured to cause an electronic device to execute a function when the machine readable indicia is scanned by the electronic device, the function being display of information related to the owner of the product derived from a website linked to or on the electronic device.

The information delivery system may advantageously allow linking of the personal information of an individual to the products they own, so that they can optimise their environmental behavior and profile.

In a particularly preferred embodiment, the consumer product is a cup formed from bioplastic material comprising used coffee grounds, as described in relation to the first aspect of the invention, above. Thus the invention may provide an information delivery system for consumer products, the system comprising: one or more machine readable indicia printed or otherwise coupled to an outer surface of a cup formed from bioplastic material comprising used coffee grounds.

An exemplary information delivery system may comprise one or more machine readable indicia printed or otherwise coupled to an outer surface of the product, or the embedding of a smart label into the product which can communicate wirelessly with an electronic device.

### EIGHTH ASPECT OF THE INVENTION

A eighth aspect of the invention may advantageously provide a method for delivering information associated with a product, the method comprising: printing or otherwise coupling at least one machine readable indicia to an outer surface of the product wherein the machine readable indicia is configured to cause an electronic device to execute a function when the machine readable indicia is scanned by the electronic device, the function being display of information related to the owner of the product derived from a website on the electronic device.

### DETAILED DESCRIPTION—FOURTH, FIFTH AND SIXTH ASPECTS OF THE INVENTION

Currently only a small segment of the plastics industry uses bio-based plastics. The reasons for this are simple. Bio-based polymers usually more expensive to produce than all oil based alternatives. Also, many bio-based plastics on the market do not offer a large enough functional improvement to justify a premium price. Therefore, there has been considerable interest in the development and use of more environmentally friendly alternatives to oil based plastics and this has prompted exploration of the use of wood or plant based fibres as additives to plastics and polymers as a way of reducing oil use and the environmental damage done. These plant fibre-reinforced polymers have found use in a number of industrial sectors to replace part of the plastics.

Biodegradability, compostability and recyclability of bio-based plastics may offer a significant added value in terms of sustainability. However, associated performance and costs still hinder the full marketability and competitiveness of biodegradable, compostable or recyclable bio-based plastics compared with their fossil-based counterparts. Therefore, there is a specific challenge to develop biodegradable, compostable or recyclable bio-based polymers that can compete with fossil-based counterparts in terms of price, performance and environmental sustainability on a cradle-to-cradle basis.

We (Patent Applications CN103725253B, WO2015104565A2) have described previously that use of a bioadhesive that is reinforced fibrous biomass containing protein and lipid has been used in addition to plant fibres to make bio-based plastic in which the biomass content can be incorporated into standard plastic materials at high level to cost and performance challenges associated with bio-based polymers.

The bioadhesive is manufactured using Distiller's Grain (DG), Distiller's Dry Grain and Solubles (DDGS), Algae and other biomass which contains cellulose, protein and lipid as raw materials. It has been processed with other additives into fine dry powder form (mesh size 40-400 mesh size, Cambond bio-resin, CN103725253B, WO2015104565A2). The bioadhesive is used to mix with virgin plastics in addition to other natural plant fibres to make bioplastic compound pellets. Other plastic process additives can be added to improve the appearance, process flow-ability, anti-thermal and light degradation properties of the material facilitating its performance during the process and daily use.

The Cambond bioadhesive is based on Distiller's Grain (DG), Distiller's Dry Grain and Solubles (DDGS) which containing protein levels up to 35% and lipid up to 10%. The additional plant fibres includes, but not limited to, used coffee bean grounds soya bean fibres after the soya bean is processed into beverage or oil, sugar beets residues after sugar has been extracted and other by products of food processing and other plant fibres.

The virgin plastics used to make the bioplastics are any thermoplastics including polypropylene, polyethylene (low density and high density), polystyrene, polyvinyl chloride and thermo-plastic polyurethane, acrylonitrile butadiene styrene (ABS), and fully biodegradable polymers such as PLA, PGA or their copolymer, or any other biodegradable polymers such as Polyhydroxy(butyrate-co-valerate) (PHBV), poly(butylene succinate) (PBS), poly(butylene adipate-co-terephthalate) (PBAT), polyhydroxy(butyrate-co-valerate)/poly(butylene succinate), (PHBV/PBS) blend and PBAT/PHBV blend, which is suitable for injection, extrusion blowing and compress moulding.

Other classes of polymer can include any thermo-setting polymers including phenol-formaldehyde resin, urea-formaldehyde resin, Melamine resin and any natural and synthetic rubber, which can be cured during process to form a moulded thermo-setting end product.

Re-cycled plastics can also be used to substitute in part or for the whole of the virgin plastics component.

Thus, the manufacturing of bioplastics consists the following steps:

For Thermo-Plastics Based Bioplastics:

Thus the process will have the following steps:

Mix thermoplastic virgin polymer 30-60%, 10-60% Cambond bio-resin and 10-60% plant fibres to make up to 100%. The blend is pelletised using a standard twin-screw extrusion equipment to obtain bioplastic pellets. The bioplastic pellets can also contain other polymer process additives such as pigments, anti-UV oxidants, lubricants, and tougheners if it is required.

For make bioplastic based products: Using above formulated compounding pellets with injection moulding and blowing moulding equipment, various products can be produced such as re-useable coffee cups to replace disposable paper cups, containers, coat hangers, plates for plantation, pots for gardening.

For Thermo-Setting Based Bioplastic:

Step 1: Mix Cambond Bio-resin, plant fibers and thermo-setting pre-polymers and filled into a hot press-moulding equipment or a vacuum press machine. As in step 1 the weight ratio of Cambond bio-resin is in the range of 10-60%, preferably in the range of 10-50%, and most preferably in the range of 20-40%. The plant fibres are in the range of 10-60%, preferably in the range of 10-50% and most preferably in the range of 10-30%. The rest part is the thermo-setting pre-polymer to make to 100%.

Step 2: The thermo-setting pre-polymers used in the process include formaldehyde base resin such as urea-formaldehyde resin, phenol-formaldehyde resin, melamine urea-formaldehyde resin, melamine resin, and non-formaldehyde based resin such as MDI and any other currently used non-formaldehyde wood adhesives.

For the thermosetting bioplastic, the level of the formaldehyde based resin and melamine resin applied in the process is in the range of 2-40% based on dry weight of total biomass fibres, preferably in the range of 4-30% and most preferably in the range of 10-30%.

The level of the non-formaldehyde based resin such as MDI resin applied in the process is in the range of 0.5-6% based on the dry weight of fibre, preferably in the range of 1-5%, most preferably in the range of 2-3%.

In this invention, the protein level in the Cambond bio-resin is in the range of 6-40%, preferably in the range of 6-30%, most preferably in the range of 8-20%. This can be achieved by select one of more of biomass to get optimised protein level for this invention.

In this invention, the lipid level in the Cambond bio-resin is in the range of 2-15%, preferably in the range of 2-10%, most preferably in the range of 2-8%. This can be achieved by select one of more of biomass to get optimised lipid level for this invention. Although the invention has been described in connection with specific preferred embodiments, it should be understood that the invention as claimed should not be unduly limited to such specific embodiments, various applications of the described modes of carrying out the invention which are obvious to those skilled in the art are intended to be covered by the present invention.

### DETAILED DESCRIPTION—SEVENTH AND EIGHTH ASPECTS OF THE INVENTION

The present application is directed to enabling the personal information of a consumer to be linked to a consumer product. In particular the interests and goals of an individual in relation to their actions and behaviours in minimizing environmental damage or their production of carbon as a way of achieving environmental goals or to comply with other desired behaviours and aims.

An exemplary information delivery system may comprise one or more machine readable indicia printed or otherwise coupled to an outer surface of the product. The readable indicia or machine communicating smart label can be attached to flat or curved surfaces or embedded within the consumer product. The indicia or smart label can be attached in any way (i.e. glued, embossed, moulded, embedded) which does not impede their ability to be machine readable or communicate with other machine or electronic devices.

Attachment of readable indicia or smart labels is commonly to the bottom or reverse face of a consumer product but these orientations presented by way of example and are not intended to be limiting in any way. There are a variety of methods and techniques for attaching labels by gluing, moulding, embossing and embedding as can be appreciated by one skilled in the art. By altering the method of attachment one skilled in the art can provide for a consumer product which has a permanent or a temporary label.

The machine readable indicia or other indicia may be printed directly onto the outer surface of the product via ink jet, laser, or any other printing method. The machine readable indicia, or other indicia may first be placed on a sticker with an adhesive backing, and then applied to the outer surface of the product. Material used to print the machine readable indicia, or other indicia may comprise thermochromatic or color changing inks, or temperature indicating inks. The thermochromatic or color changing inks may be used to hide a message or other indicia which may become visible when the temperature of ink changes, such as when a hot or cold substance is placed into the product.

One skilled in the art will readily recognize that labels may be applied to containers using a variety of methods and that there may be a variety of single-label and multi-label systems other than those described above. Any such application methods or label systems may be used with the present disclosure. The above descriptions are exemplary and not to be construed as limiting in any way.

In various embodiments, the machine readable indicia may comprise any linear, 2-dimensional, or 3-dimensional indicia or code or an RFID or EAS (smart label) device as known in the art that may be machine readable or communicate with an electronic device to cause an electronic device to execute a function when the machine readable indicia is scanned by or communicates with the electronic device. For example, the machine readable indicia may comprise a High Capacity Color Barcode (HCCB) comprising a plurality of barcode shapes in combination with a plurality of colors per symbol.

In addition to the machine readable indicia noted below, other indicia, codes, or symbols, whether linear, 2-dimensional, 3-dimensional, wireless, color, or monochrome, as are known in the art may also be used in various embodiments. A list of examples of suitable indicia is given below, this list is exemplary and not to be construed as limiting in any way.
3-DI, a 2-dimensional matrix of circular symbols;
ArrayTag, a 2-dimensional matrix of groups of hexagonal symbols;
Aztec Code, a 2-dimensional square matrix of square symbols;
Codablock, a 2-dimensional array of stacked linear codes;
Code 1, a 2-dimensional matrix of horizontal and vertical bars;
Code 16K, a 2-dimensional array of stacked linear codes;
Code 49, a 2-dimensional array of stacked linear codes;
ColorCode, a 2-dimensional color matrix of square symbols;
CP Code, a 2-dimensional square matrix of square symbols;
DataGlyphs, a 2-dimensional matrix of “/” and “\” marks;
Data Matrix, a 2-dimensional square matrix of square symbols;
Datastrip Code, a 2-dimensional matrix of square symbols;
Dot Code A, a 2-dimensional square matrix of dots;
hueCode, a 2-dimensional matrix of blocks of cells in varying shades of gray;
MaxiCode, a 2-dimensional square matrix of interlocking hexagonal symbols;
MiniCode, a 2-dimensional square matrix of square symbols;
PDF 417, a 2-dimensional matrix of a combination of linear barcodes and square symbols;
Snowflake Code, a 2-dimensional square matrix of dots;
SuperCode, a 2-dimensional matrix of a combination of linear barcodes and square symbols;
Ultracode, a color or monochrome 2-dimensional array matrix of variable length strips of pixel columns; and
3D Barcode, an embossed linear barcode of lines of varying height.
Electronic Article Surveillance devices for wireless communication.
Radio frequency identification (RFID) tags

The base label indicia described above represent a sampling of exemplary machine readable indicia currently available and are not to be construed as limiting in any manner. Other linear, 2-dimensional, and 3-dimensional codes, currently known or developed in the future, are within the scope of the present disclosure.

As described previously, the indicia attached to the consumer products may comprise codes or symbols that are machine readable. According to various embodiments the consumer may use any electronic device, such as a smartphone, to read or scan the indicia. The smartphone may comprise an application that enables a reading or scanning function on the smartphone. Once the smartphone (or other electronic device such as a tablet computer or scanner coupled to a computer) reads or scans the indicia, the indicia may be configured to cause the smartphone or other device to execute a function. In one embodiment, the function executed by the smartphone may be to open a web browser program and direct the browser to a pre-designated website.

In this example, the indicia comprises a QR code and additional information concerning how the product has been used and the environmental impact of this and how this relates the environmental goals or aims of the consumer. Thus, in this embodiment the consumer has scanned the QR code has caused a machine reader to link to a curated database containing information on the use history of the product and calculations as to its environmental impact (e.g. in the case of a re-useable coffee cup—energy savings by avoiding use of disposable cups, waste prevention, carbon savings and how these relate to the personal environmental aims of the consumer).

According to various embodiments consumer products may have a plurality of individual machine readable indicia which might be related to discrete aspects of the personal information relating to the owner of the consumer product. By selecting discrete indicia the owner of the product might carry out specific actions to activate or access different domains of their data or applications to manipulate their data or use their data to interact with a third party. In this way a product owner could access their own history of the product use and carry out actions to determine the environmental impact of the product use, calculate their product carbon footprint, energy savings over the product lifetime or how many ties the product had been used.

As readily recognized by one skilled in the art, the function executed by the smartphone or other electronic device may be any function capable of being executed on an electronic computing device. For example, the function may be to display the number of times a product has been used and its carbon saving, or enable recording of progress towards some set target or reward point set by the consumer or a third party

A general flow chart of various embodiments of the process of linking the owner of a consumer product with information on how the product has been used. At least one machine readable or communicable indicia may be attached to an outer surface of the product. In various embodiments, the machine readable or communicable indicia may be imprinted, embossed, molded or embedded directly on or in the outer surface of the product. The imprinting or embossing may be carried out using any printing or image transfer method known in the art. In various embodiments, the printing or image transfer method may be an offset process in which an image is transferred from a plate to an intermediate carrier, then to the outer surface of the product. The offset process may also involve lithographic techniques. Other printing or image transfer methods may comprise, for example, flexography, pad printing, relief printing, rotogravure, screen printing, and electrophotography. According to various embodiments, the machine readable or communicable indicia may be digitally printed on the outer surface of the product using, for example, inkjet printing or laser printing. Chemical printing technologies, such as blueprint or diazo print may also be used in various embodiments. Smart labels (EAS, RFID) can be incorporated into the material used in the manufacturing process in multiple ways according to those skilled in the arts.

A wide range of computer, artificial intelligence and machine learning systems may be used to implement embodiments of the systems and methods disclosed herein. The computing systems may include one or more processors and memory arranged in a variety of configurations know to those skilled in the art. These systems would also include cloud based systems and other computing, memory and access technologies as they become available in the future. The machine readable and communicable indicia act to link an individual consumer product to memory stores, instructions and data which enable a processor to cause the computer system to control the operation and execution of the systems and instructions in the systems described herein to provide the functionality of certain embodiments. Main memory may include a number of memories including a main random access memory (RAM) for storage of instructions and data during program execution and a read only memory (ROM) in which fixed instructions are stored. Main memory may store executable code when in operation. The system further may include a mass storage device, portable storage medium drive(s), output devices, user input devices, a graphics display, and peripheral devices. The components may be connected via a single bus. Alternatively, the components may be connected via multiple buses. The components may be connected through one or more data transport means. Processor unit and main memory may be connected via a local microprocessor bus, and the mass storage device, peripheral device(s), portable storage device, and display system may be connected via one or more input/output (I/O) buses. Mass storage device, which may be implemented with a magnetic disk drive or an optical disk drive, may be a non-volatile storage device for storing data and instructions for use by the processor unit. Mass storage device may store the system software for implementing various embodiments of the disclosed systems and methods for purposes of loading that software into the main memory. Portable storage devices may operate in conjunction with a portable non-volatile storage medium, such as a floppy disk, compact disk or Digital video disc, to input and output data and code to and from the computing system. The system software for implementing various embodiments of the systems and methods disclosed herein may be stored on such a portable medium and input to the computing system via the portable storage device. Input devices may provide a portion of a user interface. Input devices may include an alpha-numeric keypad, such as a keyboard, for inputting alpha-numeric and other information, or a pointing device, such as a mouse, a trackball, stylus, or cursor direction keys. In general, the term input device is intended to include all possible types of devices and ways to input information into the computing system. Additionally, the system may include output devices. Suitable output devices include speakers, printers, network interfaces, and monitors. Display system may include a liquid crystal display (LCD) or other suitable display device. Display system may receive textual and graphical information, and processes the information for output to the display device. In general, use of the term output device is intended to include all possible types of devices and ways to output information from the computing system to the user or to another machine or computing system. Peripherals may include any type of computer support device to add additional functionality to the computing system. Peripheral device(s) may include a modem or a router or other type of component to provide an interface to a communication network. The communication network may comprise many interconnected computing systems and communication links. The communication links may be wireline links, optical links, wireless links, or any other mechanisms for communication of information. The components contained in the computing system may be those typically found in computing systems that may be suitable for use with embodiments of the systems and methods disclosed herein and are intended to represent a broad category of such computing components that are well known in the art. Thus, the computing system may be a personal computer, hand held computing device, tablets, telephone, mobile computing device, workstation, server, minicomputer, mainframe computer, or any other computing device. The computer may also include different bus configurations, networked platforms, multi-processor platforms, etc. Various operating systems may be used including Unix, Linux, Windows, Macintosh OS, Palm OS, and other suitable operating systems. Due to the ever changing nature of computers and networks, the description of the computing system is intended only as a specific example for purposes of describing embodiments. Many other configurations of the computing system are possible having more or less components.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

### Preferred Feature Clauses—Fourth, Fifth, Sixth, Seventh and Eighth Aspects

1. A cup formed from a bioplastic material, in which the bioplastic material comprises used coffee grounds.

2. A cup according to clause 1, in which the bioplastic material is a thermosetting bioplastic material.

3. A cup according to clause 1, in which the bioplastic material is a thermoplastic bioplastic material.

4. A cup according to any preceding clause, in which the bioplastic material comprises between 10% and 60% used coffee grounds by weight.

5. A cup according to any preceding clause, in which the bioplastic material comprises between 10% and 60%, or between 10% and 50%, or between 10% and 40% bioadhesive by weight.

6. A cup according to any preceding clause, comprising one or more machine readable indicia printed or embossed on an outer surface of the cup.

7. A method of forming a cup from a thermoplastic bioplastic material comprising the steps of:
injection moulding or blow moulding a thermoplastic bioplastic material to form a cup.

8. A method according to clause 7, comprising the additional first step of manufacturing a thermoplastic bioplastic material by: mixing thermoplastic polymer, bioadhesive, and used coffee grounds, to form a mixture; and extruding the mixture to form bioplastic pellets suitable for injection moulding or blow moulding.

9. A method according to clause 8, in which the mixture comprises:
30% to 60% thermoplastic polymer by weight;
10% to 60% bioadhesive by weight; and
10% to 60% used coffee grounds by weight.

10. A method of forming a cup from a thermosetting bioplastic material comprising the steps of:
hot-press moulding or vacuum pressing a thermosetting bioplastic material to form a cup.

11. A method according to clause 10, comprising the additional first step of manufacturing a thermosetting bioplastic material by: mixing thermosetting pre-polymer, bioadhesive, and used coffee grounds, to form a mixture.

12. A method according to clause 11, in which the mixture comprises:
10% to 60% bioadhesive by weight;
10% to 60% used coffee grounds by weight; and
in which the balance consists of thermosetting pre-polymer.

13. An information delivery system for a consumer product, the system comprising: one or more machine readable indicia printed or otherwise coupled to an outer surface of the product; wherein the machine readable indicia is configured to cause an electronic device to execute a function when the machine readable indicia is scanned by the electronic device, the function being display of information related to the owner of the product derived from a website linked to or on the electronic device.

14. An information delivery system according to clause 13, in which the consumer product is a cup formed from bioplastic material comprising used coffee grounds.

15. The system of clause 13, wherein at least one of the indicia is a bar code.

16. The system of clause 13, wherein at least one of the indicia is a quick response code.

17. The system of clause 13 wherein at least one of the indicia is a smart label capable of wireless connectivity such as an Electronic Article Surveillance (EAS) tags or a specially configured radio frequency identification (RFID) tag.

18. The system of clause 13, wherein the function is the display of a loyalty system or coupon on the electronic device.

19. The system of clause 13, wherein the function is downloading of product owner related applications onto the electronic device.

20. The system of clause 13, wherein the function is automatic registration of the product owner in a contest.

21. The system of clause 13, wherein the function is a sharing of product owner information with other systems.

22. The system of clause 15, wherein the bar code is configured to cause an electronic device to execute a function when the bar code is photographed by the electronic device.

23. The system of clause 16, wherein the quick response code is configured to cause an electronic device to execute a function when the quick response code is photographed by the electronic device.

24. The system of clause 17, wherein the smart label code is configured to cause an electronic device to execute a function when the quick response code is photographed by the electronic device.

25. The system of clause 13, wherein the function is the display of environmental or personal indices related to use of the product.

26. The system of clause 25, wherein the information includes information relating to the product owner's environmental or personal goals or targets.

27. The system of clause 25, wherein the information includes information relating to the environmental or personal indices of the presented product with those of other products used by the consumer.

28. A method for delivering information associated with a product, the method comprising: printing or otherwise coupling at least one machine readable indicia to an outer surface of the product wherein the machine readable indicia is configured to cause an electronic device to execute a function when the machine readable indicia is scanned by the electronic device, the function being display of information related to the owner of the product derived from a website on the electronic device.

29. The method of clause 28, wherein at least one of the indicia is a bar code.

30. The method of clause 28, wherein at least one of the indicia is a quick response code.

31. The method of clause 28, wherein at least one of the indicia is a smart label.

32 The method of clause 28 wherein at least one of the function is the display of environmental or personal indices related to use of the product.

33. The method of clause 28, wherein the information includes information relating to the product owners environmental or personal goals or targets.

34. The method of clause 28, wherein the information includes information relating to the environmental or personal indices of the presented product with those of other products used by the consumer.

35. The method of clause 29 wherein the bar code is configured to cause an electronic device to execute a function when the bar code is photographed by the electronic device.

36. The method of clause 30 wherein the quick response code is configured to cause an electronic device to execute a function when the quick response code is photographed by the electronic device.

37. The method of clause 31 wherein the smart label is configured to cause an electronic device to execute a function when the smart label is communicated to by the electronic device.

38. The method of clause 28, wherein the function is the display of relevant environmental information.

39. The method of clause 38, wherein the product information includes relevant personal information linked to goals and targets

40. The method of clause 38, wherein the product information includes relevant information about other products the product owner uses.

41. An information delivery system for consumer products, the system comprising: one or more machine readable indicia printed or otherwise coupled to an outer surface of a cup formed from bioplastic material comprising used coffee grounds.

42. The system of clause 41, wherein at least one of the indicia and the text panel is imprinted on the outer surface of the product.

43. The system of clause 41, wherein at least one of the indicia is embossed on the outer surface of the product.

44. The system of clause 41, wherein at least one of the indicia is molded on the outer surface of the product.

45. The system of clause 41, wherein at least one of the indicia is a bar code.

46. The system of clause 41, wherein at least one of the indicia is a quick response code.

47. The system of clause 41 wherein at least one of the indicia is a smart label.

48. The system of clause 41, wherein the machine readable indicia is configured to cause an electronic device to execute a function when the machine readable indicia is scanned or contacted by the electronic device.

49. The system of clause 13 when the consumer product is manufactured from a low carbon biocomposite.

50. The system of clause 13 when the consumer product is manufactured from a biocomposite containing used coffee grounds.

51. The system of clause 13 when the consumer product is manufactured from protein containing resin and biomass composite.

52. A system of clause 13 when the consumer product is manufactured from composites containing re-cycled materials.

1. A bio-composite material comprising protein-containing non-wood fibrous biomass comprising at least 6 wt % protein, and a cross-linking agent.

2. A bio-composite material according to claim 1, further comprising wood biomass.

3. A bio-composite material according to claim 1, further comprising non-protein-containing non-wood fibrous biomass comprising less than 6% protein.

4. A bio-composite material according to claim 3, in which the non-protein-containing non-wood fibrous biomass comprises one or more of: straw fibre, bamboo fibre, sugar cane fibre, or other agricultural residues.

5. A bio-composite material according to claim 1, in which the bio-composite material comprises 10-99.5 wt % protein-containing non-wood fibrous biomass, preferably 20-60 wt %, more preferably 20-50 wt %.

6. A bio-composite material according to claim 1, in which the protein-containing non-wood fibrous biomass comprises 5-40 wt % protein, preferably 5-30 wt % protein, most preferably 5-20 wt % protein.

7. A bio-composite material according to claim 1, in which the protein-containing fibrous biomass comprises one or more of: waste coffee grounds, distiller's grain (DG), DDGS, sugar beet residue, soya bean, soya bean residue, and algal biomass.

8. A bio-composite material according to claim 1, in which the bio-composite material comprises 0.5-15 wt % cross-linking agent.

9. A bio-composite material according to claim 1, in which the cross-linking agent comprises one or more of: urea-formaldehyde resin, phenol-formaldehyde resin, melamine urea-formaldehyde resin, methylene diphenyl diisocyanate (MDI), polymeric methylene diphenyl diisocyanate (pMDI), polyurethane based adhesives.

10. A bio-composite material according to claim 1, in which the bio-composite material comprises 5-30 wt % protein, preferably 5-15 wt % protein, most preferably 5-10 wt % protein.

11. A bio-composite material according to claim 1, in which the non-protein-containing non-wood fibrous biomass comprises recycled material, for example plastic-lined paper packaging.

12. A bio-composite material according to claim 11, in which the non-protein-containing non-wood fibrous biomass comprises take-away beverage and food packaging.

13. A board formed from a bio-composite material according to claim 1, in which the panel is medium-density fibreboard (MDF), high-density fibreboard (HDF), chip board, or particle board.

14. A method of forming a board from a bio-composite material according to claim 1, comprising the steps of:
hot-pressing or vacuum-pressing a bio-composite material to form a bio-composite board.

15. A method according to claim 14, comprising the additional first step of manufacturing a bio-composite material by: mixing protein-containing non-wood fibrous biomass and cross-linking agent and, optionally, wood biomass or non-protein-containing non-wood fibrous biomass, to form a mixture; and forming a mat of bio-composite material suitable for hot pressing or vacuum pressing to form a board.

16. A bioplastic material, comprising a bioadhesive, fibrous biomass and a plastic material.

17. A bioplastic material according to claim 16, in which the plastic material is a thermosetting plastic material.

18. A bioplastic material according to claim 17, in which the thermosetting plastic material is one or more of: phenol-formaldehyde resin, urea-formaldehyde resin, Melamine resin and any natural and synthetic rubber.

19. A bioplastic material according to claim 17, in which the plastic material is a thermosetting formaldehyde-based resin or melamine resin, and the bioplastic comprises 2-40% resin based on dry weight of total biomass fibres, preferably in the range of 4-30% and most preferably in the range of 10-30%.

20. A bioplastic material according to claim 17, in which the plastic material is a thermosetting non-formaldehyde based resin, such as MDI resin, and the bioplastic comprises 0.5-6 wt % resin based on the dry weight of fibre, preferably in the range of 1-5%, most preferably in the range of 2-3%.

21. A bioplastic material according to claim 16, in which the plastic material is a thermoplastic plastic material.

22. A bioplastic material according to claim 21, in which the thermoplastic plastic material is one or more of: polypropylene, polyethylene (low density and high density), polystyrene, polyvinyl chloride, and thermo-plastic polyurethane, acrylonitrile butadiene styrene (ABS), and fully biodegradable polymers such as PLA, PGA or their copolymer, or any other biodegradable polymers such as Polyhydroxy(butyrate-co-valerate) (PHBV), poly(butylene succinate) (PBS), poly(butylene adipate-co-terephatalate) (PBAT), polyhydroxy(butyrate-co-valerate)/poly(butylene succinate), (PHBV/PBS) blend and PBAT/PHBV blend.

23. A bioplastic material according to claim 21, in which the bioplastic comprises 30-60% by weight thermoplastic plastic material, preferably in the range of 30-50%, and most preferably in the range of 10-30 wt %

24. A bioplastic material according to claim 16, in which the bioplastic comprises 10-60 wt % fibrous biomass, preferably 10-50 wt %, and most preferably 10-30 wt.

25. A bioplastic material according to claim 16, in which the fibrous biomass comprises one or more of: used coffee bean grounds, soya bean ground, straw fibre, bamboo fibre, sugar cane fibre, or agricultural waste plant fibres.

26. A bioplastic material according to claim 16, in which the bioadhesive is formed from Distiller's Grain (DG), Distiller's Dry Grain and Solubles (DDGS), or algal biomass.

27. A bioplastic material according to claim 16, in which the bioplastic comprises 10-60 wt % bioadhesive, preferably 10-50 wt % bioadhesive, and most preferably 20-40 wt % bioadhesive.

28. A cup formed from a bioplastic material according to claim 16.

29. A method of manufacturing a bioplastic material, comprising the steps of: mixing a plastic material, a bioadhesive, and fibrous biomass, to form a mixture.

30. A method according to claim 29, in which the plastic material is a thermoplastic plastic material, and in which the mixture comprises:
30% to 60% thermoplastic plastic material by weight;
10% to 60% bioadhesive by weight; and
10% to 60% fibrous biomass by weight.

31. A method according to claim 29, in which the plastic material is a thermoplastic plastic material, and in which the method comprises the step of extruding the mixture to form bioplastic pellets suitable for injection moulding or blow moulding.

32. A method according to claim 29, in which the mixture comprises:
10% to 60% bioadhesive by weight;
10% to 60% used coffee grounds by weight; and
in which the balance consists of thermosetting pre-polymer.

33. A cup formed from a bioplastic material, in which the bioplastic material comprises used coffee grounds.

34. A cup according to claim 33, in which the bioplastic material is a thermosetting bioplastic material.

35. A cup according to claim 33, in which the bioplastic material is a thermoplastic bioplastic material.

36. A cup according to any of claims 33, in which the bioplastic material comprises between 10% and 60% used coffee grounds by weight.

37. A cup according to claim 33, in which the bioplastic material comprises between 10% and 60%, or between 10% and 50%, or between 10% and 40% bioadhesive by weight.

38. A cup according to claim 33, comprising one or more machine readable indicia printed or embossed on an outer surface of the cup.

39. A method of forming a cup from a thermoplastic bioplastic material comprising the steps of:
injection moulding or blow moulding a thermoplastic bioplastic material to form a cup.

40. A method according to claim 39, comprising the additional first step of manufacturing a thermoplastic bioplastic material by: mixing thermoplastic polymer, bioadhesive, and used coffee grounds, to form a mixture; and extruding the mixture to form bioplastic pellets suitable for injection moulding or blow moulding.

41. A method according to claim 40, in which the mixture comprises:
30% to 60% thermoplastic polymer by weight;
10% to 60% bioadhesive by weight; and
10% to 60% used coffee grounds by weight.

42. A method of forming a cup from a thermosetting bioplastic material comprising the steps of:
hot-press moulding or vacuum pressing a thermosetting bioplastic material to form a cup.

43. A method according to claim 42, comprising the additional first step of manufacturing a thermosetting bioplastic material by: mixing thermosetting pre-polymer, bioadhesive, and used coffee grounds, to form a mixture.

44. A method according to claim 43, in which the mixture comprises:
10% to 60% bioadhesive by weight;
10% to 60% used coffee grounds by weight; and
in which the balance consists of thermosetting pre-polymer.
